(19) United States
(12) Patent Application Publication
(10) Pub. No.: US 2012/0299325 A1
(43) Pub. Date: Nov. 29, 2012

(54) MOTOR VEHICLE HAVING A LINING MODULE, LINING MODULE AND COMPOSITE GROUP

(76) Inventor: Walter Hurler, Stadtbergen (DE)

(21) Appl. No.: 13/576,862

(22) PCT Filed: Feb. 3, 2011
(86) PCT No.: PCT/EP11/51569

§ 371 Date: Aug. 8, 2012

(30) Foreign Application Priority Data
Feb. 3, 2010 (DE) 10 2010 001 540.7

(51) Int. Cl. B60R 13/01

(52) U.S. Cl. 296/39.1

(57) ABSTRACT

A motor vehicle having at least one lining module which covers at least one part of a loading area or at least one part of a wall surface of the motor vehicle and comprises at least one base element (2, 49, 85), at least two side walls (3, 4, 27, 28, 40, 41, 47, 48, 62, 64, 66, 68, 87, 88) and at least one ceiling panel (5, 20, 31, 42, 50, 86). The base element is provided for at least partial arranging the lining module on a support. The side walls are connected to the base element at least at two opposite end sections of the base element. The ceiling panel is held on edge sections of the side walls, and the edge sections face away from the base element. The base element, side walls and ceiling panel enclose at least one hollow space (13, 17, 89, 90).

This application is a national stage completion of PCT/EP2011/051569 filed Feb. 3, 2011 which claims priority from German Application Serial No. 10 2010 001 540.7 filed Feb. 3, 2010.

### FIELD OF THE INVENTION

The present invention relates to a motor vehicle having at least one lining module, to a lining module and to a composite group having at least two lining modules.

### BACKGROUND OF THE INVENTION

DE 39 06 628 C3 has disclosed a floor platform for a chassis of trucks, in particular semitrailers, for container floors, ship decks and the like, which floor platform comprises a support structure and a cover which closes off the support structure at least on one flat side. In order to achieve the object of specifying a floor platform of the abovementioned type which has a considerably reduced overall height in comparison with the usual carrier/crossmember/plank construction and therefore results in a greater payload space for the vehicle, the support structure consists at least partially of a honeycomb structure which consists of web plates which cross one another and of covering panels which are connected to some of the edges of the web plates and enclose and reinforce the honeycomb structure, said covering panels serving at least partially as a cover.

EP 1 445 178 A1 discloses a floor for a vehicle for conveying loads, such as a truck, an industrial vehicle and the like, which comprises a plate-shaped flat platform which is designed to be fastened on longitudinal elements of the main frame of the vehicle. Here, the plate-shaped flat platform comprises a frame which, after assembly, forms at least one part of the main frame, and a plate which comprises a plurality of layers, a layer which has a cellular basic structure being arranged between a top layer and a bottom layer. The latter two layers have a limited thickness in comparison with that of the cellular basic structure layer. Transversely extending bar-shaped inserts which are part of the frame and, after assembly, form crossmembers of the main frame are embedded into the thickness of the cellular basic structure layer, which results in a composite, structurally integral and self-supporting floor.

Furthermore, DE 10 2007 020 589 A1 describes a commercial vehicle having a vehicle frame and a cargo space which has a floor, the floor comprising at least one floor panel element which is arranged in a floor receptacle of the vehicle frame. The floor panel element has at least one first layer for forming a walk-on upper side and one second layer having a honeycomb structure.

### SUMMARY OF THE INVENTION

It is the object of the present invention to provide a motor vehicle having at least one lining module, a lining module and a composite group having lining modules which are distinguished by increased practicality, flexibility and stability in comparison with known motor vehicles, lining modules and composite groups.

A motor vehicle according to the present invention has at least one lining module which covers at least one part of a loading area or at least one part of a wall surface of the motor vehicle and comprises at least one base element, at least two side walls and at least one ceiling panel, the base element being provided for the at least partial arrangement of the lining module on a support, the side walls being connected to the base element at least at two opposite end sections of said base element, and the ceiling panel being held on edge sections of the side walls, which edge sections face away from the base element, the base element, side walls and ceiling panel enclosing at least one hollow space. Correspondingly, a lining module according to the invention for covering at least a part of a loading area or a wall surface of a motor vehicle comprises at least one base element which is provided for the at least partial arrangement of the lining module on a support, at least two side walls which are connected to the base element at opposite end sections of said base element, and at least one ceiling panel which is held on edge sections of the side walls, which edge sections face away from the base element, the base element, side walls and ceiling panel enclosing at least one hollow space. A composite group according to the present invention comprises at least two lining modules of this type which are connected to one another.

According to the present invention, in contrast to known motor vehicles, lining modules and composite groups, support structures such as T-beams, I-beams, crossmembers, web plates and honeycomb elements are dispensed with in the lining module. Instead, the lining module has a hollow space which can be used in a variety of ways. For instance, lines, assemblies and control units can be accommodated in said hollow space, as in an installation duct, in a position which is protected from the outside, which is not possible in the case of known lining modules on account of the various support structures. In contrast, clean and protected line routing is possible in the interior of the lining module. Moreover, the motor vehicle, the lining module and the composite group according to the present invention are more resistant than known motor vehicles, lining modules and composite groups, since, in the case of the latter, diverse angles, corners, edges and relatively small spaces, which prove to be particularly susceptible to corrosion, occur on account of the support structures. According to the present invention, lining modules can be used quite generally both for lining or cladding or covering floors or storage regions and also for covering, in particular, vertical walls. For example, depending on the use of the lining module, the support can accordingly be a floor surface or a frame and, in particular, a vehicle frame, or a wall surface or one or more beams. In so far as the lining module is provided for lining a storage region and the base element is closed to the bottom, or in so far as the base element is depressed in a trough-like manner and/or the hollow space is closed at least partially on sides which are not enclosed by the base element, the side walls and the ceiling panel, unintentionally released liquids, dusts or other bulk materials can be collected in the hollow space in the case of the transport of problematic transported goods, as a result of which the penetration of said materials into the ground soil is prevented. In the case of a use of the lining module to line a base or bearing surface, in order to ensure mechanical stability of said lining module, although the dimensions of the lining module are limited depending on the materials which are used to manufacture it, a plurality of lining modules can be positioned next to one another in any desired orientation with respect to one another, in order to line relatively large surfaces. As a consequence, a motor vehicle according to the invention can have a plurality of lining modules with areas which are small in comparison with the area of the region to be lined, instead of, as in the case of known motor vehicles, a few large-area lining modules or even only one lining module with supporting structures being provided for floor surfaces. Here, the lining modules can be manufactured both by machine and manually in a very wide variety of overall heights and sizes, and from a very wide variety of materials and with a very wide variety of strengths. Furthermore, the base element and/or the side walls can be shaped quite generally in any desired manner. For instance, at least one of the side walls can be curved in any desired manner. However, the side walls are preferably of substantially planar or plate-like configuration.

In principle, in the lining module, the ceiling panel can be held releasably or non-releasably on the side walls. For example, the ceiling panel can be adhesively bonded, riveted, nailed or welded to the edge sections of the side walls. A releasable holding means can be realized by means of screw connections, tenon joints, fasteners or latching devices. Here, the edge sections of the side walls can be configured to be angled away and can serve as bearing or supporting surface for the ceiling panel. Secondly, the edge sections can have groove-like depressions, into which the ceiling panel can be pushed with respective edge sections, or else rail-like projections can be formed on the edge sections of the side walls, onto which projections a ceiling panel which is provided with corresponding groove-like depressions can be pushed. Releasably held ceiling panels can advantageously be replaced quickly and conveniently, without it being necessary for the complete lining module to be replaced to this end. Thus, for example, in the case of a lining module which is used to line a storage region, the ceiling panel can be replaced in a simple way by a food-safe ceiling panel, in so far as the storage region is to be converted for the storage of foodstuffs. In this way, the lining module can be adapted without problems to a very wide variety of requirements which are made of the nature of the materials which come into contact with stored material.

Depending on the requirements, the ceiling panel can be configured in any desired manner. The ceiling panel preferably is or comprises at least one wood panel and/or at least one film coated plywood panel and/or at least one metal panel and/or at least one stainless steel panel and/or at least one aluminum panel and/or at least one corrugated panel and/or at least one diamond plate. Furthermore, the ceiling panel can have at least one recess.

The base element and the side walls are preferably configured as a single-piece shaped profile. A shaped profile of this type is distinguished by a simple and cheap production method and by particularly high stability.

The lining module particularly preferably has at least one connecting device for the releasable or non-releasable connection of the lining module to an adjacent lining module or an adjacent part of a lining module. Here, the base element and/or the ceiling panel and/or at least one of the side walls can enclose the connecting device at least partially or completely. Adjacent lining modules or parts of lining modules can be adhesively bonded, riveted, welded, screwed, nailed, fastened, mortised or latched to one another by way of corresponding connecting devices, in order to secure the lining modules, for example, against mutual displacement. Lining modules can also be joined in an abutting or clinkered manner or by overlapping, also by inverting, to form units or composite groups. In particular, the lining modules can be of stackable configuration, by bottom sides and top sides of individual lining modules being shaped such that they can be fitted inside one another. Lining modules of this type can be stacked one above another, for example, for height compensation, which is advantageous, in particular, in the case of motor vehicles with semitrailers. Furthermore, by the lining modules being stacked one above another, a plurality of planes of said lining modules can be formed, or a plurality of planes of shafts by a corresponding arrangement of lining modules with hollow spaces which are continuous and are open on both sides.

In a lining module, the side walls can be different or equally long in a longitudinal direction of the lining module. Side walls of different length are preferred, for example, when two lining modules which are oriented at right angles to one another are joined to one another, of which one comprises side walls of different length and the respectively other lining module engages into a recess of the first lining module, which recess is exposed by the shorter side wall.

One embodiment of the present invention has a lining module which comprises an insulating material or is lined with an insulating material. Lining modules of this type are preferably used for lining at least one part of a wall.

Quite generally, the hollow space can extend in a freely continuous manner in a longitudinal direction of the lining module and can be open on both sides and/or at least one functional element can be arranged in the hollow space. The functional element can be as desired. For example, the functional element can be a holding or clamping device for fixing cables or cable looms which are guided through the hollow space, or a transverse or front wall which can have as many openings as desired. In the case of relatively great loadings of the lining module, the functional element can also be a web plate which is provided at a corresponding location for the mechanical reinforcement of the lining module, for example is welded into the lining module.

The side walls of the lining module can be oriented parallel to one another, or they can form an angle. For instance, at least one of the side walls can form, with the base element and/or with the ceiling panel, a right angle or an angle which is less than or greater than 90°. Lining modules which are configured in this way can engage, for example, into recesses of bounding elements of a region to be lined, for improved space utilization. Furthermore, the side walls can taper in a wedge-shaped manner toward one another in a longitudinal direction of the lining module, in order also to line surfaces with changing dimensions as completely as possible with lining modules.

### BRIEF DESCRIPTION OF THE DRAWINGS

In the following text, preferred embodiments of the invention will be explained in greater detail using Figures, in which:

FIG. 1A shows cross sections through a plurality of different lining modules,

FIG. 1B shows a plan view of a lining module,

FIG. 2 shows a composite group,

FIG. 3A shows a side view of two lining modules which are connected to one another, FIG. 3B shows a plan view of the lining modules, FIG. 3C shows a cross sectional view through the lining modules along section line 3C-3C of FIG. 3B, FIG. 3d is an enlarged detail of the side view of FIG. 3A and FIG. 3E is, in turn, an enlarged detail of FIG. 3C,

FIG. 4 shows a truck, the loading area of which is lined with lining modules, while FIG. 4A is a diagrammatic top plan view of the truck of FIG. 4,

FIG. 5 shows a further truck, the loading area of which is lined with lining modules, while FIG. 5A is a diagrammatic top plan view of the truck of FIG. 5,

FIG. 6 shows a further truck, the loading area of which is lined with lining modules, while FIG. 6A is a diagrammatic top plan view of the truck of FIG. 6,

FIG. 7 shows a further truck, the loading area of which is lined with lining modules, while FIG. 7A is a diagrammatic top plan view of the truck of FIG. 7,

FIG. 8 shows a further truck, the loading area of which is lined with lining modules, while FIG. 8A is a diagrammatic top plan view of the truck of FIG. 8,

FIG. 9 shows a further truck, the loading area of which is lined with lining modules, while FIG. 9A is a diagrammatic top plan view of the truck of FIG. 9, and

FIG. 10 shows a further truck, the loading area of which is lined with lining modules, while FIG. 10A is a diagrammatic top plan view of the truck of FIG. 10.

### DETAILED DESCRIPTION OF THE INVENTION

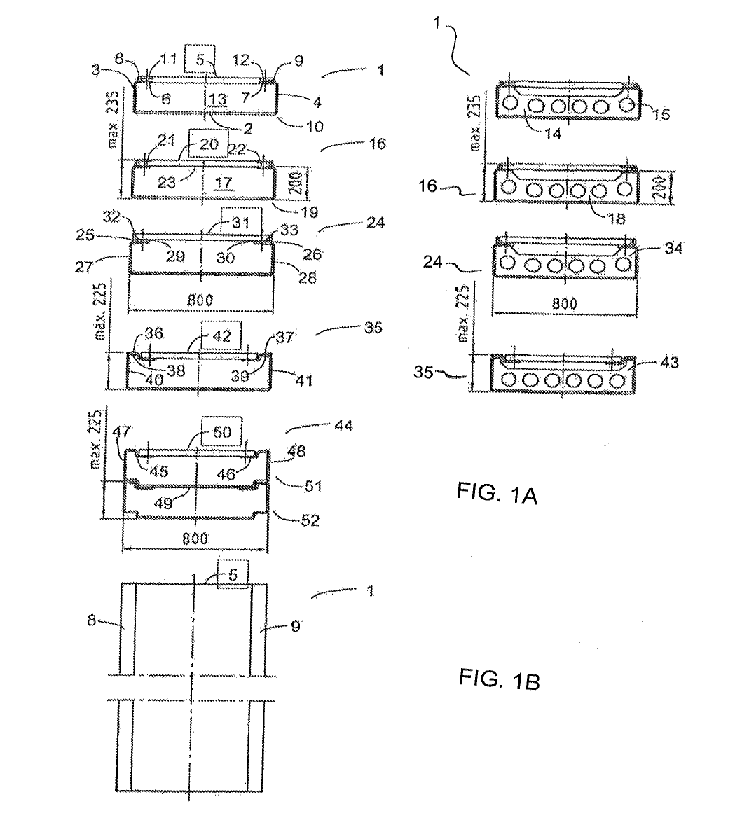

FIG. 1A shows various elongate lining modules for covering at least a part of a loading area or a wall surface of a motor vehicle in cross section, whereas FIG. 1B shows, by way of example, a plan view of one of the lining modules to be seen in FIG. 1A. Dimensions in FIG. 1A and in all following figures are in each case in mm.

A lining module (1) which is shown in FIG. 1A has a plate-shaped base element (2), two side walls (3) and (4) which are perpendicular with respect to the base element (2) at mutually opposite ends or edge sections of said base element (2), and a ceiling panel (5). One edge section (6) of the side wall (3) which faces away from the base element (2) is angled away at a right angle from the side wall (3), so as to face the side wall (4), and is therefore oriented parallel to the base element (2). Correspondingly, an edge section (7) of the side wall (4) which faces away from the base element (2) is angled away at a right angle from the side wall (4), so as to face the side wall (3), and is therefore oriented parallel to the base element (2). On a side of the edge sections (6) and (7) which faces away from the base element (2), respective L-profiles (8) and (9) are placed with the respectively shorter side onto the edge sections (6) and (7) in such a way that the L-profiles (8) and (9) and the edge sections (6) and (7) delimit respective channel-formed grooves, the open sides of which face one another. The base plate (2), side walls (3) and (4) including their edge sections (6) and (7) and the L-profiles (8) and (9) are manufactured in one piece from a shaped profile and form a base frame (10) of the lining module (1). The ceiling panel (5) is a film coated plywood panel. On two opposite sides, the ceiling panel (5) has in each case one elongate projection (11) and (12) which extends along the sides of the ceiling panel (5) and has a smaller thickness in comparison with the thickness of the ceiling panel (5). Here, the projections (11) and (12) are arranged centrally with regard to the thickness or height of the ceiling panel (5). The ceiling panel (5) is pushed with the projections (11) and (12) into a respective one of the grooves which are formed by the edge sections (6) and (7) and by the L-profiles (8) and (9). The base element (2), side walls (3) and (4) and the ceiling panel (5) therefore enclose or delimit a hollow space (13) which extends through the entire length of the lining module (1).

A plan view of the lining module (1) can be seen in FIG. 1B.

In the lining module (1), the ceiling panel (5) is pushed with the projections (11) and (12) merely into the grooves which are formed by the edge sections (6) and (7) and by the L-profiles (8) and (9) and is not connected to the base frame (10) of the lining module (1). It is also possible, however, to connect the ceiling panel (5) releasably or non-releasably to the base frame (10) and/or to the side walls (3) and (4). For example, openings which are in each case aligned with one another can be provided at uniform spacings in the edge section (6), in the L-profile (8) and in the projection (11), through which openings screws can be plugged, in order to make a screwed connection possible between the ceiling panel (5) and side wall (3). Corresponding openings can be provided in the edge section (7), in the projection (9) and in the L-profile (12). In this way, the ceiling panel (5) can be connected firstly to the base frame (10). Secondly, the ceiling panel (5) can be separated simply and quickly from the base frame (10) by releasing of the screwed connection, and can be removed or replaced.

The hollow space (13) can be used to accommodate various functional elements. Thus, for example, one or more transverse walls (14) can be inserted into the hollow space (13). Accordingly, the lining module (1) can be seen once with and once without a transverse wall (14) of this type in FIG. 1A. In the present case, the transverse wall (14) has a plurality of circular openings (15) which are provided for fixing cables or cable looms.

Various modifications of the lining module (1) are possible.

Thus, in the case of the lining module (16) which can likewise be seen in FIG. 1A and is shown once without and once with a transverse wall (18) which is arranged in its hollow space (17), the embodiment of its base frame (19) is identical, for example, to that of the base frame (10) of the lining module (1). In contrast, the lining module (16) has a ceiling panel (20) with lateral projections (21) and (22) which are flush with a bottom side (23) of the ceiling panel (20).

In the case of another lining module (24) which is manufactured from curved metal sheet, respective edge sections (25) and (26) of the side walls (27) and (28) are curved in such a way that they form bearing surfaces (29) and (30) with respective lateral stops (32) and (33) for a ceiling panel (31). The ceiling panel (31) is a simple plate without projections, which lies with opposite edge sections in each case on the bearing surfaces (29) and (30) and bears with opposite sides in each case against the stops (32) and (33). The lining module (24) can also be seen once without and once with a transverse wall (34).

A modification of the lining module (24) is represented by the lining module (35), in which Z-profiles (36) and (37) are welded on angled-away edge sections (38) and (39) of the side walls (40) and (41) in such a way that, similarly to the lining module (24), there are supports for a plate-shaped ceiling panel (42). As in the previous examples, the lining module (35) is also shown once without and once with a transverse wall (43).

Finally, FIG. 1A shows a lining module (44), in which angled-away edge sections (45) and (46) of the side walls (47) and (48) are configured in a stepped manner. Moreover, its base element (49) is depressed in the center in a trough-like manner. A ceiling panel (50) lies on the edge sections (45) and (46). As a consequence of the special configuration of its base frame (51), the lining module (44) can be placed onto the base frame (52) of a further correspondingly configured lining module, in so far as the ceiling panel has been removed in the case of this further lining module. In this way, any desired number of base frames of lining modules of this type can be stacked.

As in the case of the lining module (1), the respective ceiling panels can also be connected releasably or non-releasably to the respective base frames in the case of all the other lining modules which are shown.

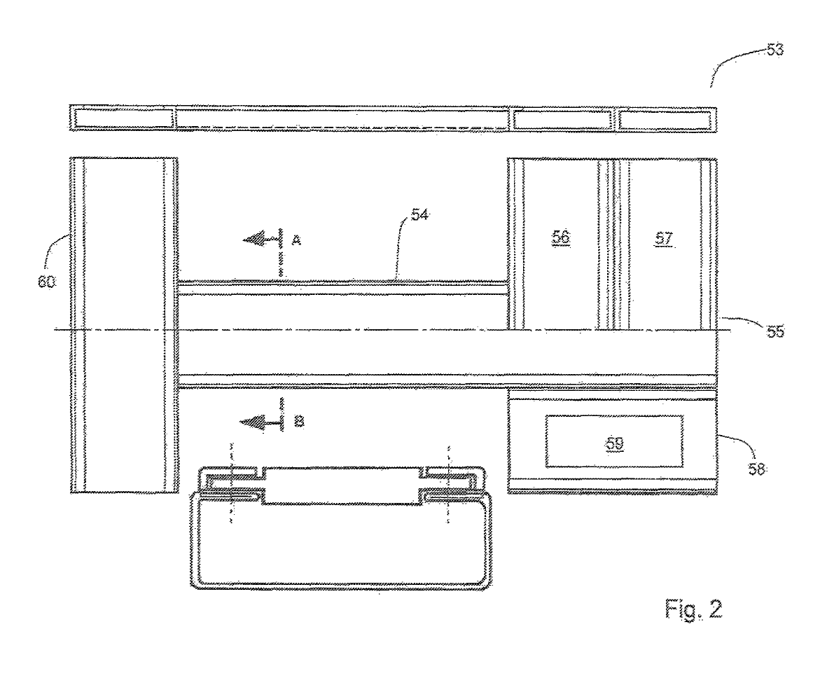

FIG. 2 shows a composite group (53) which comprises a plurality of various lining modules which are connected to one another. Here, the composite group (53) can be seen once in side view and once in plan view. Furthermore, a cross section through the composite group (53) along a line A-B is shown.

The composite group (53) is provided for lining the floor of a loading area of a truck, and is therefore also called a floor group. It consists of an elongate lining module (54), the cross section of which corresponds substantially to that of the lining module (1) from FIG. 1A. On one side, an end section of the lining module (54) has a lateral recess (55) which extends as far as the center of the lining module (54). Two lining modules (56) and (57) which lie on one another with their side walls and are oriented at right angles to the lining module (54) engage partially into said recess (55). At the level of the recess (55), a lining module (58) which is oriented parallel to the lining module (54) lies on the lining module (54) on a side which faces away from the recess (55). In its ceiling panel, the lining module (58) has a recess (59) which is provided for a wheel arch of the truck. Moreover, on an end side of the lining module (54), which end side is opposite the end section with the recess (55), a lining module (60) which is oriented at right angles to said lining module (54) bears against the lining module (54), with the result that the lining modules (54) and (60) substantially form a T-shape. All the lining modules (54), (56), (57), (58) and (60) have the same height, their respective top sides and their respective bottom sides being flush with one another.

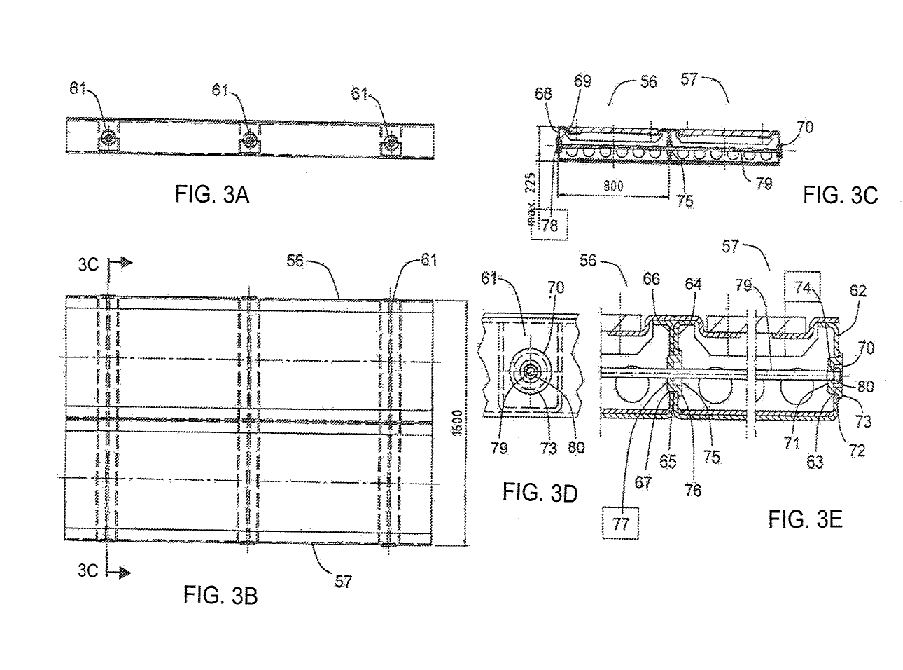

The lining modules (56) and (57) which bear laterally against one another are shown in greater detail in FIG. 3. Here, FIG. 3a) shows a side view of the lining modules (56) and (57) and FIG. 3B shows a plan view of the lining modules (56) and (57). In FIGS. 3A and 3B, connecting devices (61) can be seen, by way of which the lining modules (56) and (57) are connected releasably to one another. FIG. 3C shows a cross section through the lining modules (56) and (57) along a line 3C-3C which is illustrated in FIG. 3b) and extends through one of the connecting devices (61). One of the connecting devices (61) can be seen in FIG. 3D, which is an enlarged detail of the side view from FIG. 3a), whereas FIG. 3E in turn is an enlarged detail of FIG. 3C.

As can be seen, in particular, in FIGS. 3C and 3E, a side wall (62), facing away from the lining module (56), of the lining module (57) has an opening (63), a side wall (64), facing the lining module (56), of the lining module (57) has an opening (65), a side wall (66), facing the lining module (57), of the lining module (56) has an opening (67), and a side wall (68), facing away from the lining module (57), of the lining module (56) has an opening (69). All the openings (63), (65), (67) and (69) are aligned with one another. An insert element (70) having a substantially U-shaped cross section is inserted into the side wall (62), which insert element (70) has a base (71), a circumferential side wall (72) and, at an end of the side wall (72) which is opposite the base (71), a circumferential protrusion (73). A through hole (74) is provided in the base (71). The insert element (70) extends through the opening (63), the base (71) projecting into the hollow space of the lining module (57), and the protrusion (73) bearing against an outer surface of the side wall (62). An insert element (75) which corresponds to the insert element (70) extends through the openings (65) and (67). In the case of the insert element (75), however, its circumferential protrusion (76) bears against an inner surface of the side wall (64) and is connected fixedly to the latter, whereas its base (77) projects partially into the hollow space of the lining module (56). Finally, an insert element (78) which corresponds to the insert elements (70) and (75) extends through the opening (69), which insert element (78) bears with its protrusion against an outer surface of the side wall (68) and protrudes with its base into the hollow space of the lining module (56). A rod (79), the end sections of which in each case have an external thread, extends through the holes of the insert elements (70), (75) and (78) and transversely through the hollow spaces of the lining modules (56) and (57). A respective threaded nut (80) is screwed onto each of said external threads. Here, neither the rod (79) nor the respective threaded nuts (80) project beyond a surface of the insert elements (70) and (78). As a consequence of the insert element (75) which extends through the openings (65) and (67), the lining modules (56) and (57) are secured against mutual displacement, whereas the rod (79) and the threaded nuts (80), after being tightened, connect the lining modules (56) and (57) releasably to one another or prevent the lining modules (56) and (57) from detaching from one another.

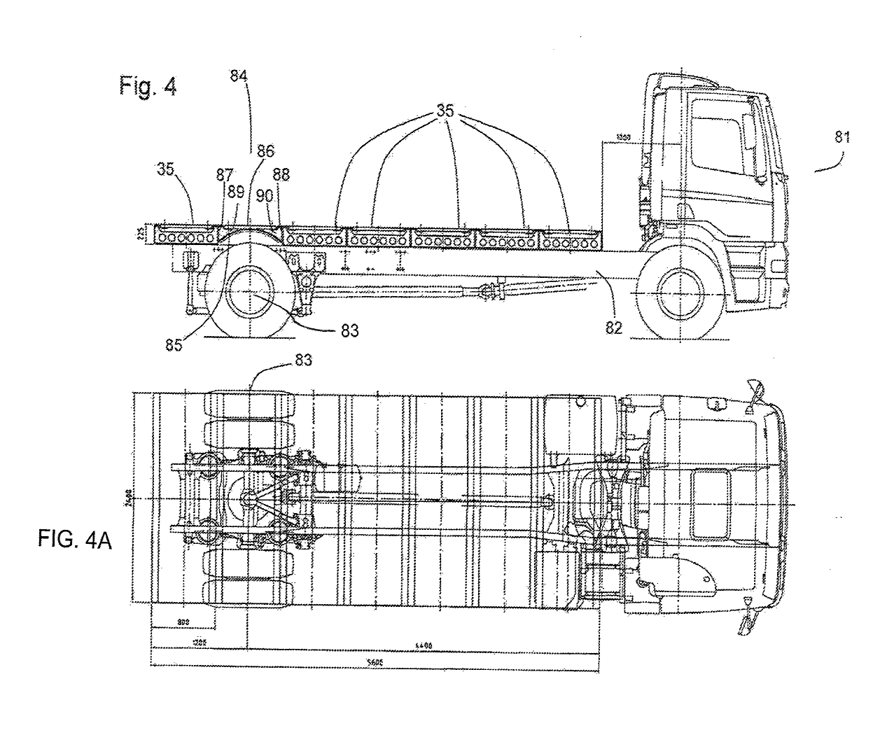

FIG. 4 shows a side view and FIG. 4A is a plan view of a truck (81) having a loading area which is lined or clad, inter alia, with a plurality of lining modules (35) according to FIG. 1A. The lining modules (35) are oriented transversely with respect to a longitudinal axis of the truck and bear in each case against one another with their side surfaces. They lie with their base elements on a frame (82) of the truck (81), which frame (82) serves as a support for the base elements. A lining module (84) with a base element (85) which is curved in the shape of a circular section and with a ceiling panel (86) and two side walls (87) and (88) is arranged above a rear wheel axle (83) of the truck (81). The base element (85) butts centrally against the ceiling panel (86), as a result of which two hollow spaces (89) and (90) are formed in the lining module (84). Here, the hollow space (89) is enclosed by a part of the base element (85), a part of the ceiling panel (86) and the side wall (87), whereas the hollow space (90) is enclosed by a part of the base element (85), a part of the ceiling panel (86) and the side wall (88). Here, the aligned ceiling panels of all the lining modules (35) and (84) form a loading surface of the loading area or the loading platform of the truck (81). Here, the lining modules (35) and (84) can be mounted, for example, individually on the truck (81), or individual ones or all of the lining modules (35) and (84) can be connected to form one or more composite groups which are mounted on the truck (81).

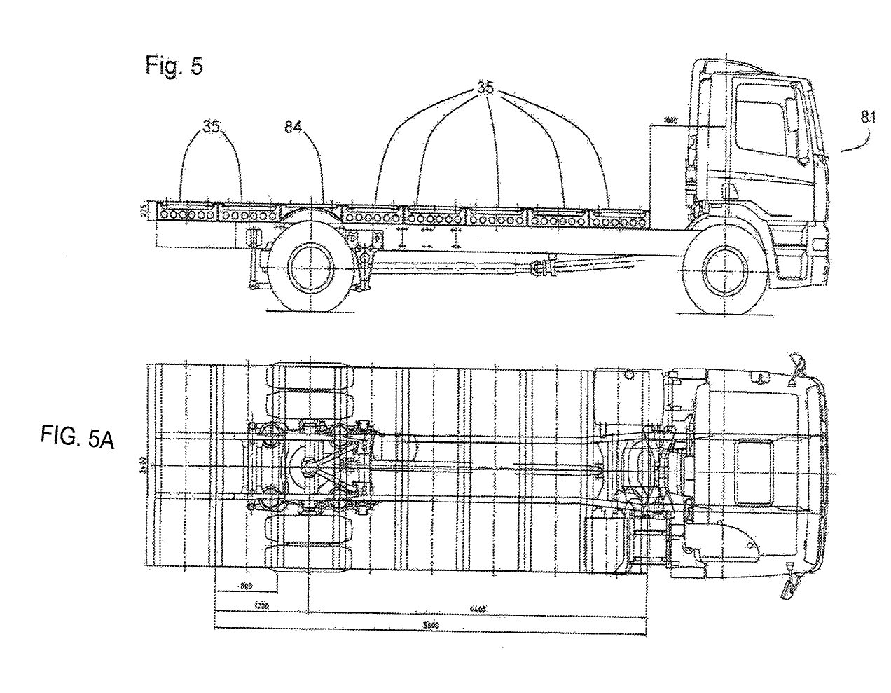

In FIG. 4, only one further lining module (35) is provided on that side of the lining module (84) which faces the rear side of the truck (81). However, according to requirements, as many further lining modules as possible can be arranged on this side. For instance, FIG. 5 shows the case in which an additional lining module (35) is provided on the rear side in order to enlarge the loading area of the truck (81) and FIG. 5A is a plan view thereof.

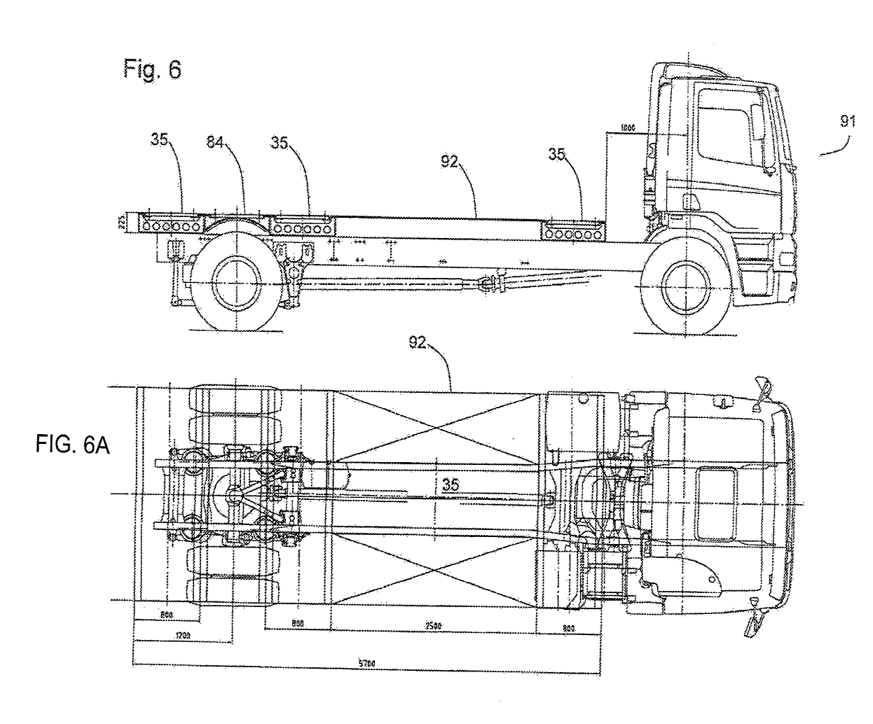

FIG. 6 shows a truck (91) and FIG. 6A is a plan view thereof in which a part of its loading area is taken up by a lifting apparatus (92) with a left-hand and a right-hand lifting platform as viewed in the driving direction of the truck (91). A lining module (35) according to FIG. 1A is arranged between the lifting platforms. In the longitudinal direction of the truck (91), the loading area is lined on both sides of the lifting apparatus (92) with lining modules (35) according to FIG. 1A which are oriented transversely with respect to the longitudinal axis of the truck (91) and with a lining module (84) according to FIG. 4.

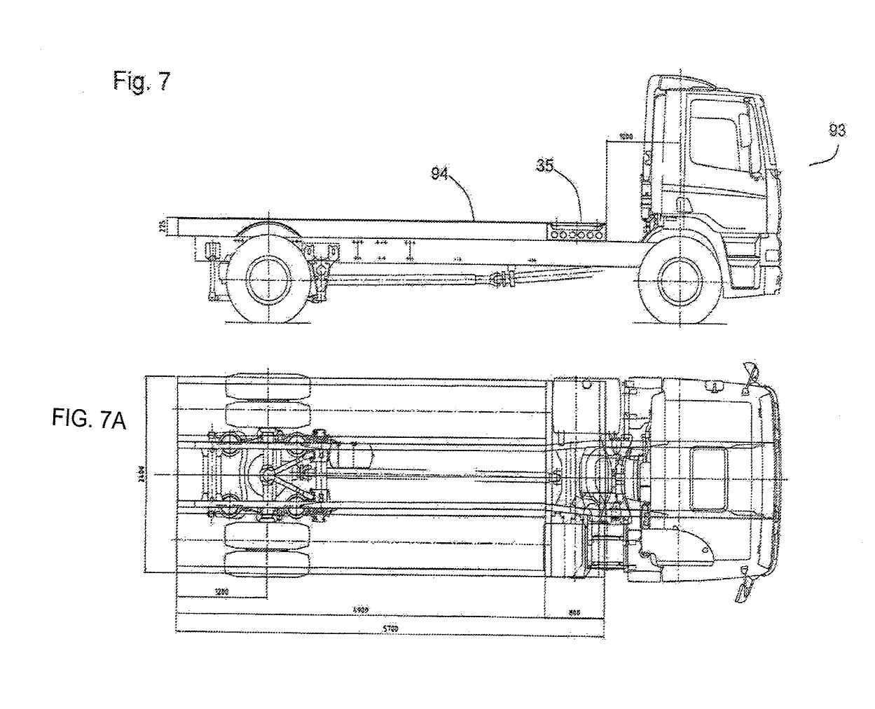

In the case of the truck (93) which is shown in FIG. 7, and FIG. 7A is a plan view thereof, a front end section of the loading area is provided with a lining module (35) according to FIG. 1A which is oriented transversely with respect to the longitudinal axis of the truck (93). Three lining modules (94) which are oriented parallel to the longitudinal direction of the truck (93) and bear laterally against one another lie on that side wall of the lining module (35) which faces the rear side of the truck (93), which lining modules (94) extend continuously from the lining module (35) as far as the end of the loading area of the truck (93) and the base elements of which in each case have a curved section which is arranged above the rear axle of the truck (93).

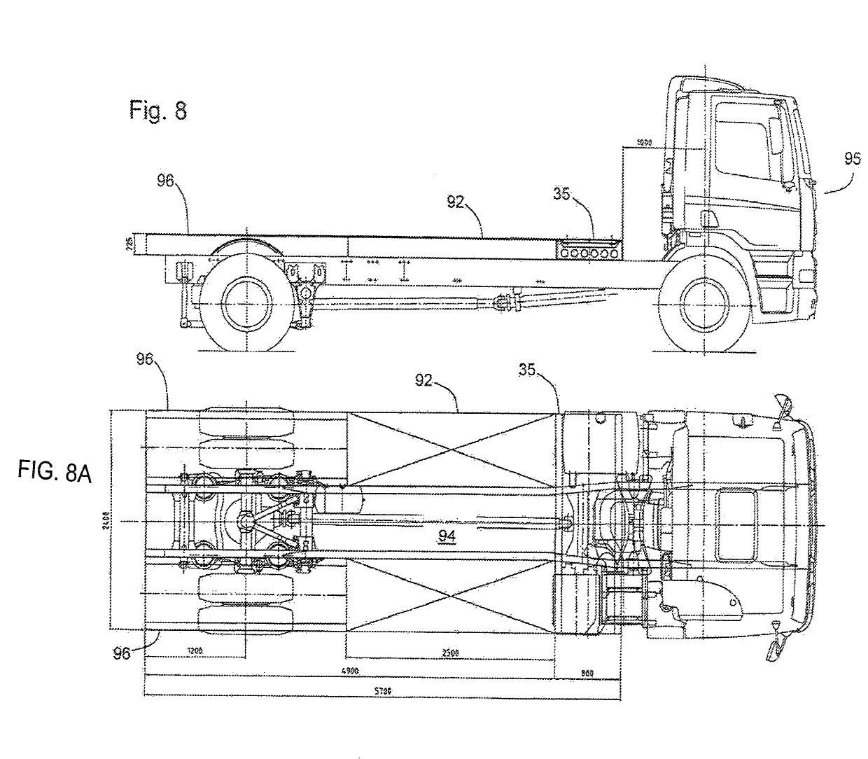

In the case of the truck (95) of FIG. 8 (FIG. 8A is a plan view thereof), as in the previous case of FIG. 7, a front end section of the loading area is provided with a lining module (35) according to FIG. 1A which is oriented transversely with respect to the longitudinal axis of the truck (95). Toward the rear side of the truck (95), a lifting apparatus (92) according to FIG. 6 adjoins the lining module (35) with a left-hand and a right-hand lifting platform as viewed in the driving direction of the truck (95). Between the lifting platforms, a lining module (94) according to FIG. 7 which is oriented parallel to the longitudinal axis of the truck (95) extends from the lining module (35) as far as the end of the loading area. On the left and right of the lining module (94) as viewed in the driving direction of the truck (95), in each case one lining module (96) which is oriented parallel to the longitudinal axis of the truck (95) bears on both sides with a side surface against the lining module (94) and with an end surface against the lifting apparatus (92). The lining modules (96) have base elements with an arcuate section which is central in the longitudinal direction and is positioned above the rear axle of the truck (95).

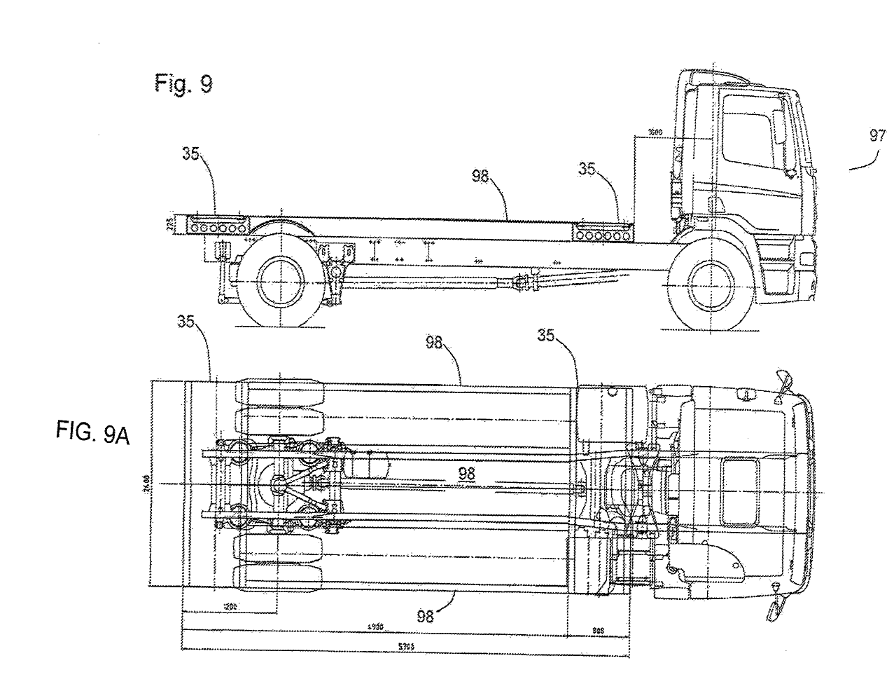

At a front and a rear end section of its loading area, the truck (97) of FIG. 9 (FIG. 9A is a plan view thereof) in each case has a lining module (35) according to FIG. 1A which is oriented transversely with respect to the longitudinal axis of the truck (97). Three lining modules (98) which are arranged next to one another and are oriented parallel to the longitudinal axis of the truck (97) extend in between, the base elements of which lining modules (98) in each case have an arcuate section in a rear end section, which arcuate section is positioned above the rear axle of the truck (97).

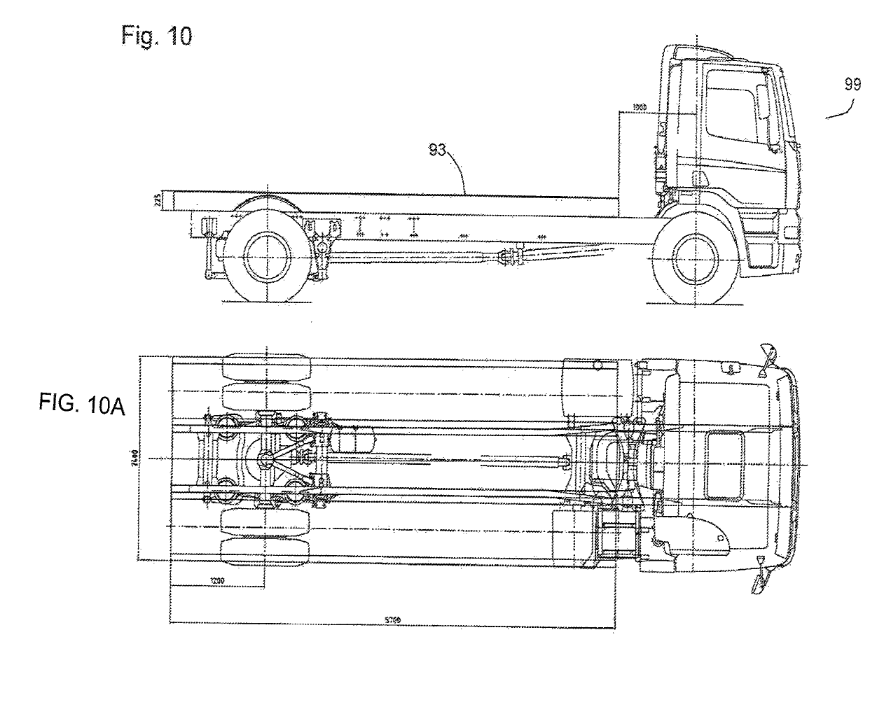

Finally, in the case of the truck (99) of FIG. 10 (FIG. 10A is a plan view thereof), a loading area is lined with three lining modules (93) according to FIG. 7 which are arranged next to one another, are oriented parallel to the longitudinal axis of the truck (99) and in each case have an arcuate section which is positioned above the rear axle of the truck (99).

1-11. (canceled)

12. A motor vehicle (81, 91, 93, 95, 97, 99) having at least one lining module (1, 16, 24, 35, 44, 54, 56, 57, 58, 60, 84, 94, 96, 98) which covers at least one part of a loading area or at least one part of a wall surface of the motor vehicle (81, 91, 93, 95, 97, 99) and comprises at least one base element (2, 49, 85), at least two side walls (3, 4, 27, 28, 40, 41, 47, 48, 62, 64, 66, 68, 87, 88) and at least one ceiling panel (5, 20, 31, 42, 50, 86),
the base element (2, 49, 85) being provided for the at least partial arrangement of the lining module (1, 16, 24, 35, 44, 54, 56, 57, 58, 60, 84, 94, 96, 98) on a support (82),
the side walls (3, 4, 27, 28, 40, 41, 47, 48, 62, 64, 66, 68, 87, 88) being connected to the base element (2, 49, 85) at least at two opposite end sections of the base element (2, 49, 85),
the ceiling panel (5, 20, 31, 42, 50, 86) being held on edge sections (6, 7, 25, 26, 38, 39, 45, 46) of the side walls (3, 4, 27, 28, 40, 41, 47, 48, 62, 64, 66, 68, 87, 88), which edge sections (6, 7, 25, 26, 38, 39, 45, 46) face away from the base element (2, 49, 85), and
the base element (2, 49, 85), side walls (3, 4, 27, 28, 40, 41, 47, 48, 62, 64, 66, 68, 87, 88) and ceiling panel (5, 20, 31, 42, 50, 86) enclosing at least one hollow space (13, 17, 89, 90).

13. The motor vehicle (81, 91, 93, 95, 97, 99) according to in claim 12, wherein the ceiling panel (5, 20, 31, 42, 50, 86) is one of releasably and non-releasably held on the side walls (3, 4, 27, 28, 40, 41, 47, 48, 62, 64, 66, 68, 87, 88).

14. The motor vehicle (81, 91, 93, 95, 97, 99) according to in claim 12, wherein the ceiling panel (5, 20, 31, 42, 50, 86) comprises at least one of a wood panel, a film coated plywood panel, a metal panel, a stainless steel panel, an aluminum panel a corrugated panel and a diamond plate and the ceiling panel (5, 20, 31, 42, 50, 86) has at least one recess (59).

15. The motor vehicle (81, 91, 93, 95, 97, 99) according to in claim 12, wherein the base element (2, 49, 85) and the side walls (3, 4, 27, 28, 40, 41, 47, 48, 62, 64, 66, 68, 87, 88) are configured as a single-piece shaped profile.

16. The motor vehicle (81, 91, 93, 95, 97, 99) according to in claim 12, wherein the lining module (56, 57) has at least one connecting device (61) for one of releasable or non-releasable connecting the lining module (56, 57) to an adjacent lining module (56, 57) or an adjacent part of a lining module (56, 57).

17. The motor vehicle (81, 91, 93, 95, 97, 99) according to in claim 12, wherein the side walls is one of different and equally long in a longitudinal direction of the lining module (54).

18. The motor vehicle (81, 91, 93, 95, 97, 99) according to in claim 12, wherein the lining module (1, 16, 24, 35, 44, 54, 56, 57, 58, 60, 84, 94, 96, 98) comprises one of an insulating material and is lined with an insulating material.

19. The motor vehicle (81, 91, 93, 95, 97, 99) according to in claim 12, wherein the hollow space (13, 17, 89, 90) of the lining module (1, 16, 24, 35, 44, 54, 56, 57, 58, 60, 84, 94, 96, 98) extends in a freely continuous manner in a longitudinal direction of the lining module (1, 16, 24, 35, 44, 54, 56, 57, 58, 60, 84, 94, 96, 98) and is open on both sides thereof.

20. The motor vehicle (81, 91, 93, 95, 97, 99) according to in claim 12, wherein at least one functional element (14, 18, 34, 43) is arranged in the hollow space (13, 17, 89, 90).

21. The motor vehicle (81, 91, 93, 95, 97, 99) according to in claim 12, wherein the hollow space (13, 17, 89, 90) of the lining module (1, 16, 24, 35, 44, 54, 56, 57, 58, 60, 84, 94, 96, 98) extends in a freely continuous manner in a longitudinal direction of the lining module (1, 16, 24, 35, 44, 54, 56, 57, 58, 60, 84, 94, 96, 98) and is open on both sides thereof, and at least one functional element (14, 18, 34, 43) is arranged in the hollow space (13, 17, 89, 90).

22. The motor vehicle (81, 91, 93, 95, 97, 99) according to in claim 12, wherein the side walls (3, 4, 27, 28, 40, 41, 47, 48, 62, 64, 66, 68, 87, 88) of the lining module (1, 16, 24, 35, 44, 54, 56, 57, 58, 60, 84, 94, 96, 98) are oriented parallel to one another.

23. The motor vehicle (81, 91, 93, 95, 97, 99) according to in claim 12, wherein the side walls (3, 4, 27, 28, 40, 41, 47, 48, 62, 64, 66, 68, 87, 88) of the lining module (1, 16, 24, 35, 44, 54, 56, 57, 58, 60, 84, 94, 96, 98) form an angle with one another.

24. A lining module (1, 16, 24, 35, 44, 54, 56, 57, 58, 60, 84, 94, 96, 98) for covering at least one part of a loading area or a wall surface of a motor vehicle (81, 91, 93, 95, 97, 99) having at least one lining module (1, 16, 24, 35, 44, 54, 56, 57, 58, 60, 84, 94, 96, 98) which covers at least one part of a loading area or at least one part of a wall surface of the motor vehicle (81, 91, 93, 95, 97, 99) and comprises at least one base element (2, 49, 85), at least two side walls (3, 4, 27, 28, 40, 41, 47, 48, 62, 64, 66, 68, 87, 88) and at least one ceiling panel (5, 20, 31, 42, 50, 86), the base element (2, 49, 85) being provided for the at least partial arrangement of the lining module (1, 16, 24, 35, 44, 54, 56, 57, 58, 60, 84, 94, 96, 98) on a support (82), the side walls (3, 4, 27, 28, 40, 41, 47, 48, 62, 64, 66, 68, 87, 88) being connected to the base element (2, 49, 85) at least at two opposite end sections of the base element (2, 49, 85), the ceiling panel (5, 20, 31, 42, 50, 86) being held on edge sections (6, 7, 25, 26, 38, 39, 45, 46) of the side walls (3, 4, 27, 28, 40, 41, 47, 48, 62, 64, 66, 68, 87, 88), which edge sections (6, 7, 25, 26, 38, 39, 45, 46) face away from the base element (2, 49, 85), and the base element (2, 49, 85), side walls (3, 4, 27, 28, 40, 41, 47, 48, 62, 64, 66, 68, 87, 88) and ceiling panel (5, 20, 31, 42, 50, 86) enclosing at least one hollow space (13, 17, 89, 90);
wherein lining module (1, 16, 24, 35, 44, 54, 56, 57, 58, 60, 84, 94, 96, 98) comprises at least one base element (2, 49, 85) which is provided for the at least partial arrangement of the lining module (1, 16, 24, 35, 44, 54, 56, 57, 58, 60, 84, 94, 96, 98) on a support (82),
at least two side walls (3, 4, 27, 28, 40, 41, 47, 48, 62, 64, 66, 68, 87, 88) which are connected to the base element (2, 49, 85) at opposite end sections of the base element (2, 49, 85) and at least one ceiling panel (5, 20, 31, 42, 50, 86) which is held on edge sections (6, 7, 25, 26, 38, 39, 45, 46) of the side walls (3, 4, 27, 28, 40, 41, 47, 48, 62, 64, 66, 68, 87, 88), which edge sections (6, 7, 25, 26, 38, 39, 45, 46) face away from the base element (2, 49, 85), and
the base element (2, 49, 85), side walls (3, 4, 27, 28, 40, 41, 47, 48, 62, 64, 66, 68, 87, 88) and ceiling panel (5, 20, 31, 42, 50, 86) enclosing at least one hollow space (13, 17, 89, 90).

25. A composite group (53) having at least two lining modules (3, 4, 27, 28, 40, 41, 47, 48, 62, 64, 66, 68, 87, 88) according to claim 24 which are connected to one another.
